(19) United States
(12) Patent Application Publication
(10) Pub. No.: US 2007/0192187 A1
(43) Pub. Date: Aug. 16, 2007

(54) Rewarding frequent fliers with last seat availability

(75) Inventors: Mark Douglas Becker, New York, NY (US); Alissa Judith Butterfass, New York, NY (US); Eva Reda, Glen Ridge, NJ (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/412,093

(22) Filed: Apr. 27, 2006

Related U.S. Application Data
(60) Provisional application No. 60/691,289, filed on Jun. 17, 2005.

(51) Int. Cl. G06Q 30/00; G06Q 10/00

(52) U.S. Cl. 705/14; 705/5

(57) ABSTRACT

An airline may offer two procedures for redeeming frequent flier miles for tickets on a specified flight of that airline, with one procedure available to frequent flier program members that do not have transactional cards associated with the frequent flier program, and another redemption procedure available to frequent flier program members that have a transactional card associated with the frequent flier program. Cardmembers have improved award seat availability for frequent flier mile redemption, regardless of their status in the frequent flier program. Cardmembers are provided with last seat availability at a base redemption rate. Thus, cardmembers are not subject to limited award seat capacity controls and restrictions that airline frequent flier programs have in place, and cardmembers do not have to use higher redemption rates for last seat availability.

### CROSS REFERENCE TO RELATED APPLICATIONS

This application claims the benefit of U.S. Provisional Patent Application No. 60/691,289, filed Jun. 17, 2005, which is incorporated by reference herein in its entirety.

### BACKGROUND OF THE INVENTION

1. Field of the Invention

The present invention relates to loyalty-based rewards programs, specifically frequent flier rewards programs.

2. Background Art

Many airlines offer a frequent flier program as a rewards program for loyal passengers.

Once a passenger has accrued a certain number of frequent flier miles, the passenger may redeem those miles in exchange for a ticket on the associated airline. However, airlines place capacity controls and limits on the number of seats available for mileage redemption. This causes difficulties in the redemption process, as customers often cannot redeem their frequent flier miles for their desired flight. These controls cause customer frustration and dissatisfaction. They also devalue frequent flier mileage as currency, because those miles cannot be used as the customer would like, or as the customer was promised.

The situation has become increasingly worse. Customers have been accruing miles and building their balances over many years, and there are evermore opportunities to earn frequent flier miles through airlines and their partners. At the same time, airlines have reduced overall seat capacity, and airline load factors are increasing. This leads the airlines to allot fewer seats for mileage redemption.

Some airlines have attempted to combat this problem by increasing award seat availability for customers who have attained an elite level status in their frequent flier programs. Additionally, some airlines offer a program member the ability to redeem their miles for any available seat (referred to as last seat availability) if the member redeems more miles for that seat than the standard mileage redemption rate. For example, if the capacity-controlled award seat is normally redeemed for 25,000 miles, the last seat available rate is doubled, or equal to 50,000 miles.

These solutions still result in customer dissatisfaction, because the customer may not be eligible for elite status, or may not be willing to pay double for last seat availability. What is needed is a system and method for allowing customers greater flexibility in choosing their award seats.

### BRIEF SUMMARY OF THE INVENTION

The above-mentioned problems can be solved by providing frequent flier program members with an improved award seat availability redemption process, regardless of their status on that airline. A transactional card company can collaborate with an airline to provide a transactional card, such as a credit card, that is linked to the airline's frequent flier program. The airline may offer two procedures for redeeming frequent flier miles for tickets on a specified flight of that airline, with one procedure available to frequent flier program members that do not have transactional cards associated with the frequent flier program, and another redemption procedure available to frequent flier program members that have a transactional card associated with the frequent flier program. Cardmembers are provided with last seat availability at the lowest published redemption rate, regardless of whether they are general or elite members of the frequent flier program. That is, if there is a seat available on the flight for purchase, the cardmember will be able to redeem the cardmember's miles for that seat at a lowest and/or base rate.

Because of this process, cardmembers are not subject to the limited award seat capacity controls and restrictions that airlines have in place, and they do not need to use a more expensive, higher redemption rate, such as double miles, to attain last seat availability.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flowchart of an example redemption process for frequent flier program members that do not have a transactional card associated with the frequent flier program.

FIG. 2 is a flowchart of an example redemption process for frequent flier program members that have a transactional card associated with the frequent flier program.

FIG. 3 is a block diagram of an exemplary computer system useful for implementing the present invention.

The present invention will be described with reference to the accompanying drawings.

The drawing in which an element first appears is typically indicated by the leftmost digit(s) in the corresponding reference number.

### DETAILED DESCRIPTION OF THE INVENTION

I. Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

The terms “user,” “consumer,” “customer,” “participant,” “cardmember” and/or the plural form of these terms are used interchangeably throughout herein to refer to those persons or entities capable of accessing, using, being affected by and/or benefiting from the tool that the present invention provides for rewarding frequent fliers with last seat availability.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

1. Transaction Accounts and Instrument

A “transaction account” as used herein refers to an account associated with an open account or a closed account system (as described below). The transaction account may exist in a physical or non-physical embodiment. For example, a transaction account may be distributed in non-physical embodiments such as an account number, frequent flier account, telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

2. Open Versus Closed Cards

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer, such as The Gap® store.

3. Stored Value Cards

Stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in the account associated with the card before use of the card is allowed. For example, if a customer deposits ten dollars of value into the account associated with the stored value card, the card may only be used for payments together totaling no more than ten dollars.

4. Use of Transaction Accounts

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

5. Account and Merchant Numbers

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit; debit, prep aid, telephone, embossed, smart, magnetic stripe, bar code, transponder or radio frequency card).

The account number may be distributed and stored in any form of plastic, electronic, magnetic, radio frequency (RF), wireless, audio and/or optical device capable of transmitting or downloading data from itself to a second device. A customer account number may be, for example, a sixteen-digit credit card number. Each credit card issuer has its own numbering system, such as the fifteen-digit numbering system used by American Express Company of New York, N.Y. Each issuer's credit card numbers comply with that company's standardized format such that an issuer using a sixteen-digit format will generally use four spaced sets of numbers in the form of:
N₁N₂N₃N₄ N₅N₆N₇N₈ N₉N₁₀N₁₁N₁₂ N₁₃N₁₄N₁₅N₁₆

The first five to seven digits are reserved for processing purposes and identify the issuing institution, card type, etc. In this example, the last (sixteenth) digit is typically used as a sum check for the sixteen-digit number. The intermediary eight-to-ten digits are used to uniquely identify the customer, card holder or cardmember.

A merchant account number may be, for example, any number or alpha-numeric characters that identifies a particular merchant for purposes of card acceptance, account reconciliation, reporting and the like.

Persons skilled in the relevant arts will understand the breadth of the terms used herein and that the exemplary descriptions provided are not intended to be limiting of the generally understood meanings attributed to the foregoing terms.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

II. Frequent Flier Rewards

A transactional card company, such as American Express Company of New York, N.Y., can collaborate with a merchant to produce a rewards or incentive program. This rewards program can be made possible by the merchant's investment in the program. The merchant may be, e.g., an airline company, such as Delta Air Lines, Inc., of Atlanta, Ga.

For example, a frequent flier program may be linked with a transaction account provided by the transactional card company, such that a customer gains miles based on the customer's frequent use of the transaction account. The miles may accumulate in a frequent flier account related to the transaction account. After a number of miles have accumulated in the customer's frequent flier account, the customer may be able to redeem the miles in exchange for products and/or services provided by the related merchant, such as an airline ticket. Additionally, membership in the transactional account miles rewards program may qualify the customer for additional services and/or amenities.

Although the present invention will be described herein with reference to an airline company's frequent flier program, one of skill in the pertinent art(s) will recognize that a similar program may be implemented with other types of service providers without departing from the spirit and scope of the present invention. Further, although the present invention will be described with reference to specific categories and mile amounts, one of skill in the pertinent art(s) will recognize that other categories and mile amounts may be used without departing from the spirit and scope of the present invention.

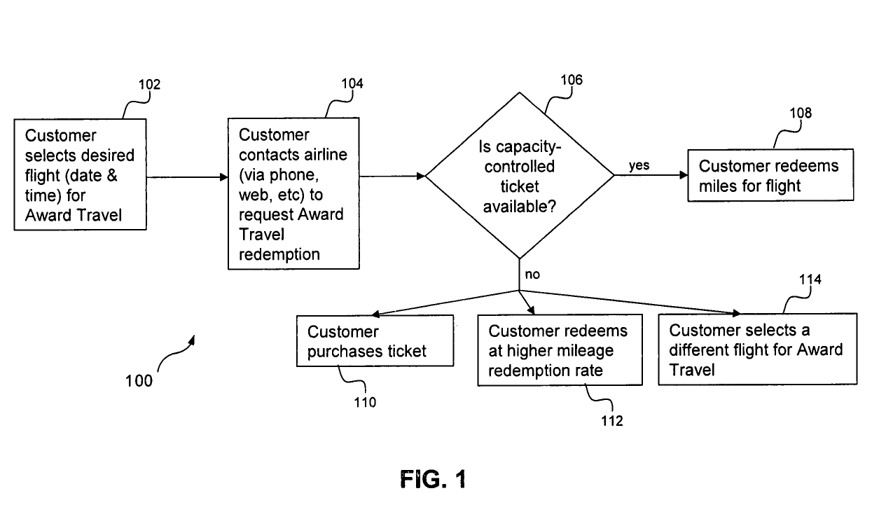

FIG. 1 is a flowchart of an example method 100 for the purchase of an airline ticket through a frequent flier program by a generic program member. In step 102, a frequent flier program member selects a desired flight with the associated airline company for redemption through the frequent flier program. The desired flight may have a specified travel date and time. Method 100 then proceeds to step 104. In step 104, the customer contacts the airline to request redemption using frequent flier miles.

When an airline opens a flight, a number of seats may be set aside for frequent flier program members. Some of these seats may be available to any seat availability tier (e.g., general tier and elite tier), and are referred to as “capacity-controlled” seats. Capacity-controlled seats are typically available to frequent flier program members in exchange for frequent flier miles at a base redemption rate. After the capacity-controlled seats fill up with booked passengers, a minimal number of seats are available for “last seat availability” redemption. These last seats are in high demand, prompting the airline to charge higher redemption rates for these seats to frequent flier program members, and/or reserve these seats only for frequent flier program members who have attained a higher status based on their frequent flier program account balance.

In step 106, it is determined whether a capacity-controlled seat is available for the requested flight. If it is determined that a capacity-controlled seat is available, method 106 proceeds to step 108. In step 108, the customer redeems miles in the customer's frequent flier program account at a base redemption rate for a ticket on the requested flight. During this redemption, the customer's frequent flier account is reduced by the number of miles exchanged for the ticket.

If it is determined in step 106 that a capacity-controlled seat is not available, the customer is not allowed to redeem the customer's miles for a ticket on the requested flight at the normal, base redemption rate. Instead, method 106 proceeds to one of three optional steps 110, 112, or 114. In step 110, the customer does not redeem any miles, and purchases the ticket (e.g., using cash or a transaction card). In step 112, the customer redeems miles from the customer's frequent flier account at a higher redemption rate than the base redemption rate. For example, the higher redemption rate may be double the base redemption rate. The customer is then provided with a ticket on the requested flight. In step 114, the customer is not provided with a ticket on the requested flight, but redeems miles at the base redemption rate for a ticket on a different flight.

With method 100, some members of the frequent flier program are unable to redeem their miles for a requested flight at a base redemption rate. This problem may be avoided by providing an alternative redemption process to customers who hold a transactional account associated with the frequent flier program.

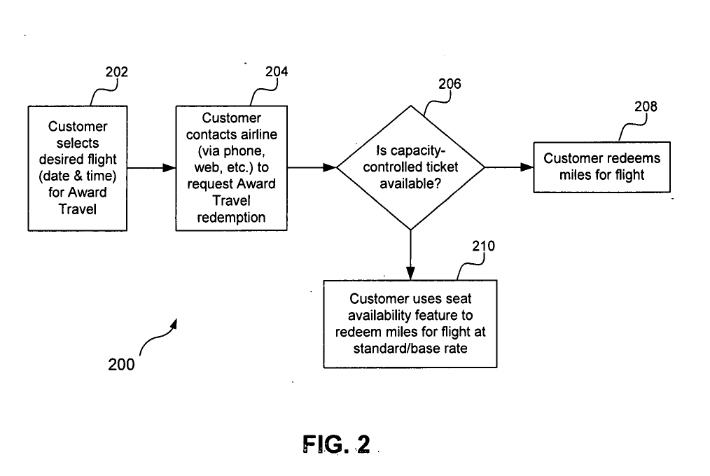

FIG. 2 is a flowchart of an example method 200 for redemption of frequent flier program miles by a holder of a transactional account associated with the frequent flier program. For example, the redeemer, also referred to as the cardmember, may have a credit card that is co-branded by the airline company and the transactional account company. In step 202, the cardmember selects a desired flight with the associated airline company for redemption through the frequent flier program. The desired flight may have a specified travel date and time. Method 200 then proceeds to step 204. In step 204, the cardmember contacts the airline to request redemption using frequent flier miles.

In step 206, it is determined whether a capacity-controlled award ticket is available on the requested flight. If it is determined that a capacity-controlled award ticket is available on the requested flight, method 200 proceeds to step 208. In step 208, the cardmember redeems miles in the cardmember's frequent flier program account for a ticket on the requested flight.

If it is determined in step 206 that a capacity-controlled award ticket is not available on the requested flight, method 200 proceeds to step 210. In step 210, the cardmember takes advantage of the seat availability feature offered to cardmembers to redeem miles from the cardmember's frequent flier program at the base redemption rate. Under this seat availability feature, the cardmember is not subject to the tiered nature of the airline's frequent flier program. The seat availability feature may be available to all cardmembers having the co-branded transactional card. Alternatively, only those cardmembers meeting a given spend requirement in a given time period, such as $10,000 a year, may be eligible for the seat availability feature. Still alternatively, only those cardmembers whose transactional account has a particular status with the frequent flier program (e.g., “platinum” status as opposed to “classic” or “gold” status) may be eligible for the seat availability feature.

In this manner, the airline provides one redemption process (e.g., the method of FIG. 1) for frequent flier program members that do not have an associated transactional card, and another redemption process (e.g., the method of FIG. 2) for frequent flier program members having an associated transactional card.

Additional benefits may be provided to the cardmembers associated with the airline company's frequent flier program. Such additional benefits may be provided, for example, to any cardmember associated with the airline company's frequent flier program, cardmembers meeting a given spend requirement, or cardmembers whose transactional accounts have a particular status with the frequent flier program. For example, an acquisition bonus, such as a 15,000 miles acquisition bonus, may be awarded when the cardmember joins the frequent flier program. Elevated status, such as elite status, in the frequent flier program may automatically be awarded to a cardmember having the frequent flier transactional card.

After the initial miles acquisition bonus, the cardmember may be rewarded additional miles for various types of spend. One type of spend is spend at the airline associated with the frequent flier program. For example, the cardmember may be rewarded two miles for every dollar spent at the associated airline. Another type of spend is every day spend (“EDS”). EDS includes, for example and without limitation, spend at grocery stores, gas stations, drug stores, postal service providers, home improvement stores, and wireless telephone companies. For EDS, for example, a cardmember may be rewarded two miles for every dollar spent.

All other spend may be placed in a different category, wherein the cardmember receives a different point value. For example, the cardmember may receive one mile for every dollar spent on other goods and services.

A renewal bonus may be given to the cardmember every time the cardmember renews membership in the rewards program. The bonus may be based on the cardmember's level of spend in a given time period. For example, a cardmember may be given a renewal bonus of 10,000 miles for a spend level of $25,000 in the previous year.

Additional services and/or amenities (referred to herein as “additional services”) may also be offered to a cardmember having the frequent flier transactional card. These additional services may be offered, for example, to any cardmember having the frequent flier transactional card, only to cardmembers with a minimum level of spend, or only to cardmembers whose transactional accounts have a particular status with the frequent flier program.

One example of an additional service is free access to an airline club room for cardmembers. Free access may also be granted to the immediate family of the cardmember or to a given number of guests of the cardmember. Another example of an additional service is a complimentary concierge service, available at all times. Yet another example of additional service is a complimentary travel counselor, available at all times. The travel counselor may be, for instance, an award planner.

Still another example of an additional service is air miles insurance. Air miles insurance protects the airline miles in a frequent flier account in case the frequent flier program changes. Reasons for a change in the frequent flier program may include liquidation of the airline offering the program or discontinuance of the program by the airline. The insurance may protect all miles in a frequent flier account, or it may protect miles up to a maximum amount. The cardmember may automatically receive such air miles insurance, or the cardmember may have to apply for the air miles insurance. An example air miles insurance program is described in commonly-owned, co-pending U.S. patent application Ser. No. ______, filed ______ (attorney docket no. 2348.0390001), which is incorporated herein by reference in its entirety.

One of skill in the pertinent art(s) will recognize that other additional services, including other travel services and shopping services, may be linked to the frequent flier transactional account without departing from the spirit and scope of the present invention.

III. Example Implementations

The present invention or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

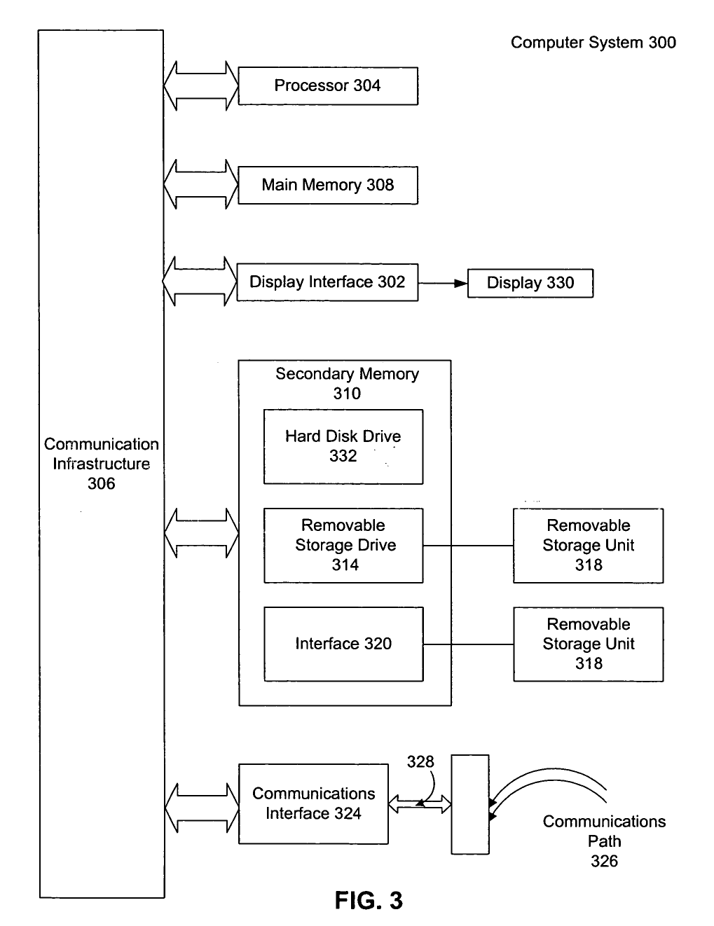

In fact, in one embodiment, the invention is directed toward one or more computer systems capable of carrying out the functionality described herein. An example of a computer system 300 is shown in FIG. 3.

The computer system 300 includes one or more processors, such as processor 304. The processor 304 is connected to a communication infrastructure 306 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 300 can include a display interface 302 that forwards graphics, text, and other data from the communication infrastructure 306 (or from a frame buffer not shown) for display on the display unit 330.

Computer system 300 also includes a main memory 308, preferably random access memory (RAM), and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner. Removable storage unit 318 represents a floppy disk, magnetic tape, optical disk, etc. which is read by and written to by removable storage drive 314. As will be appreciated, the removable storage unit 318 includes a computer usable storage medium having stored therein computer software and/or data.

In alternative embodiments, secondary memory 310 may include other similar devices for allowing computer programs or other instructions to be loaded into computer system 300. Such devices may include, for example, a removable storage unit 318 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 318 and interfaces 320, which allow software and data to be transferred from the removable storage unit 318 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328 which may be electronic, electromagnetic, optical or other signals capable of being received by communications interface 324. These signals 328 are provided to communications interface 324 via a communications path (e.g., channel) 326. This channel 326 carries signals 328 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 314, a hard disk installed in hard disk drive 312, and signals 328. These computer program products provide software to computer system 300. The invention is directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 304 to perform the features of the present invention. Accordingly, such computer programs represent controllers of the computer system 300.

In an embodiment where the invention is implemented using software, the software may be stored in a computer program product and loaded into computer system 300 using removable storage drive 314, hard drive 312 or communications interface 324. The control logic (software), when executed by the processor 304, causes the processor 304 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### IV. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1. A method of redeeming frequent flier miles associated with a frequent flier program, comprising:
receiving a request from a customer to redeem frequent flier miles in the customer's account for a ticket on a specified flight;
processing the request according to a first redemption procedure when the customer does not have a transactional account associated with the frequent flier program; and
processing the request according to a second redemption procedure when the customer has a transactional account associated with the frequent flier program.

2. The method of claim 1, wherein processing the request according to the second redemption procedure comprises:
redeeming the frequent flier miles for a capacity-controlled seat at a base redemption rate when a capacity-controlled seat is available; and
redeeming the frequent flier miles for a non-capacity-controlled seat at the base redemption rate when no capacity-controlled seats are available.

3. The method of claim 2, wherein processing the request according to the first redemption procedure comprises:
redeeming the frequent flier miles for a capacity-controlled seat at the base redemption rate when a capacity-controlled seat is available; and
redeeming the frequent flier miles for a non-capacity-controlled seat at a higher redemption rate than the base redemption rate when no capacity-controlled seats are available.

4. The method of claim 2, wherein processing the request according to the first redemption procedure comprises:
redeeming the frequent flier miles for a capacity-controlled seat at the base redemption rate when a capacity-controlled seat is available; and
rejecting redemption of the frequent flier miles for a ticket on the specified flight when no capacity-controlled seats are available.

5. The method of claim 1, wherein processing the request according to the second redemption procedure comprises:
processing the request according to the second redemption procedure when the customer has a transactional card linked to both a transactional account and the customer's frequent flier account.

6. The method of claim 1, wherein processing the request according to the second redemption procedure comprises:
processing the request according to the second redemption procedure when the customer has a transactional card co-branded by a transactional account company and an airline associated with the frequent flier program.

7. The method of claim 1, wherein processing the request according to the second redemption procedure comprises:
processing the request according to the second redemption procedure when the customer's transactional account has a particular status with the frequent flier program.

8. The method of claim 1, further comprising:
conferring additional benefits on the customer when the customer has a transactional account associated with the frequent flier program, wherein the additional benefits include at least one of an acquisition bonus, a transactional account renewal bonus, a frequent flier program renewal bonus, elevated status in the frequent flier program, varied point awards based on types of spend, access to airport lounges, and access to concierge services.

9. A system for redeeming frequent flier miles associated with a frequent flier program, comprising:
a processor; and
a memory in communication with the processor, the memory for storing a plurality of processing instructions for directing the processor to:
receive a request from a customer to redeem frequent flier miles in the customer's account for a ticket on a specified flight;
process the request according to a first redemption procedure when the customer does not have a transactional account associated with the frequent flier program; and
process the request according to a second redemption procedure when the customer has a transactional account associated with the frequent flier program.

10. The system of claim 9, wherein the instructions for directing the processor to process the request according to the second redemption procedure comprise instructions for directing the processor to:
redeem the frequent flier miles for a capacity-controlled seat at a base redemption rate when a capacity-controlled seat is available; and
redeem the frequent flier miles for a non-capacity-controlled seat at the base redemption rate when no capacity-controlled seats are available.

11. The system of claim 10, wherein the instructions for directing the processor to process the request according to the first redemption procedure comprise instructions for directing the processor to:
redeem the frequent flier miles for a capacity-controlled seat at the base redemption rate when a capacity-controlled seat is available; and
redeem the frequent flier miles for a non-capacity-controlled seat at a higher redemption rate than the base redemption rate when no capacity-controlled seats are available.

12. The system of claim 10, wherein the instructions for directing the processor to process the request according to the first redemption procedure comprise instructions for directing the processor to:
redeem the frequent flier miles for a capacity-controlled seat at the base redemption rate when a capacity-controlled seat is available; and
reject redemption of the frequent flier miles for a ticket on the specified flight when no capacity-controlled seats are available.

13. The system of claim 9, wherein the instructions for directing the processor to process the request according to the second redemption procedure comprise instructions for directing the processor to:
process the request according to the second redemption procedure when the customer has a transactional card linked to both a transactional account and the customer's frequent flier account.

14. The system of claim 9, wherein the instructions for directing the processor to process the request according to the second redemption procedure comprise instructions for directing the processor to:
process the request according to the second redemption procedure when the customer has a transactional card co-branded by a transactional account company and an airline associated with the frequent flier program.

15. The system of claim 9, wherein the instructions for directing the processor to process the request according to the second redemption procedure comprise instructions for directing the processor to:
process the request according to the second redemption procedure when the customer's transactional account has a particular status with the frequent flier program.

16. The system of claim 9, further comprising instructions for directing the processor to:
confer additional benefits on the customer when the customer has a transactional account associated with the frequent flier program, wherein the additional benefits include at least one of an acquisition bonus, a transactional account renewal bonus, a frequent flier program renewal bonus, elevated status in the frequent flier program, varied point awards based on types of spend, access to airport lounges, and access to concierge services.

17. A computer program product comprising a computer usable medium having control logic stored therein for causing a computer to redeem frequent flier miles associate with a frequent flier program, said control logic comprising:
first computer readable program code means for causing the computer to receive a request from a customer to redeem frequent flier miles in the customer's account for a ticket on a specified flight;
second computer readable program code means for causing the computer to process the request according to a first redemption procedure when the customer does not have a transactional account associated with the frequent flier program; and
third computer readable program code means for causing the computer to process the request according to a second redemption procedure when the customer has a transactional account associated with the frequent flier program.

18. The computer program product of claim 17, wherein said third computer readable program code means comprise:
fourth computer readable program code means for causing the computer to redeem the frequent flier miles for a capacity-controlled seat at a base redemption rate when a capacity-controlled seat is available; and
fifth computer readable program code means for causing the computer to redeem the frequent flier miles for a non-capacity-controlled seat at the base redemption rate when no capacity-controlled seats are available.

19. The computer program product of claim 18, wherein said second computer readable program code means comprises:
sixth computer readable program code means for causing the computer to redeem the frequent flier miles for a capacity-controlled seat at the base redemption rate when a capacity-controlled seat is available; and
seventh computer readable program code means for causing the computer to redeem the frequent flier miles for a non-capacity-controlled seat at a higher redemption rate than the base redemption rate when no capacity-controlled seats are available.

20. The computer program product of claim 18, wherein said second computer readable program code means comprises:
sixth computer readable program code means for causing the computer to redeem the frequent flier miles for a capacity-controlled seat at the base redemption rate when a capacity-controlled seat is available; and
seventh computer readable program code means for causing the computer to reject redemption of the frequent flier miles for a ticket on the specified flight when no capacity-controlled seats are available.

21. The computer program product of claim 17, wherein said third computer readable program code means comprises:
fourth computer readable program code means for causing the computer to process the request according to the second redemption procedure when the customer has a transactional card linked to both a transactional account and the customer's frequent flier account.

22. The computer program product of claim 17, wherein said third computer readable program code means comprises:
fourth computer readable program code means for causing the computer to process the request according to the second redemption procedure when the customer has a transactional card co-branded by a transactional account company and an airline associated with the frequent flier program.

23. The computer program product of claim 17, wherein said third computer readable program code means comprises:
fourth computer readable program code means for causing the computer to process the request according to the second redemption procedure when the customer's transactional account has a particular status with the frequent flier program.

24. The computer program product of claim 17, further comprising:
fourth computer readable program code means for causing the computer to confer additional benefits on the customer when the customer has a transactional account associated with the frequent flier program, wherein the additional benefits include at least one of an acquisition bonus, a transactional account renewal bonus, a frequent flier program renewal bonus, elevated status in the frequent flier program, varied point awards based on types of spend, access to airport lounges, and access to concierge services.
